(19) United States
(12) Patent Application Publication
(10) Pub. No.: US 2016/0276093 A1
(43) Pub. Date: Sep. 22, 2016

(54) MULTILAYER INDUCTOR

(71) Applicant: FDK CORPORATION, Tokyo (JP)

(72) Inventors: Daisuke MATSUBAYASHI, Tokyo (JP); Mikio KITAOKA, Tokyo (JP); Kiyohisa YAMAUCHI, Tokyo (JP); Minako SUZUKI, Tokyo (JP)

(21) Appl. No.: 14/778,430

(22) PCT Filed: Feb. 20, 2014
(86) PCT No.: PCT/JP2014/000879

§ 371 Date: Sep. 18, 2015

(30) Foreign Application Priority Data
Mar. 25, 2013 (JP) 2013-062080

(51) Int. Cl. H01F 27/28; H01F 27/245

(52) U.S. Cl. CPC H01F 27/2804; H01F 27/245; H01F 2027/2809

(57) ABSTRACT

A multilayer inductor for reducing a difference in inductance values and suppressing magnetic interference. Plural electrically insulating magnetic layers and conductive patterns are laminated, each of the conductive patterns being connected in sequence in the lamination direction, so that two coils having substantially the same number of turns and substantially the same coil diameter are formed, the two coils are in parallel such that each coil is a mirror image with respect to a virtual surface between the coils, and ends of each coil are located at an outer peripheral part on a side opposite to the virtual surface, an electrically insulating nonmagnetic pattern corresponding in shape to each of the conductive patterns is between the conductive patterns adjacent in the lamination direction, and at least one electrically insulating nonmagnetic layer is disposed only inside the coils in the lamination direction in place of the magnetic layers.

### TECHNICAL FIELD

The present invention relates to a multilayer inductor in which two coils formed by connecting conductive patterns are disposed in electrically insulating magnetic layers that are laminated and formed.

### BACKGROUND ART

Generally, in a multilayer inductor that is surface-mounted as a power inductor or the like on a circuit board of a portable telephone or the like, a plurality of coils are disposed therein.

In this type of the multilayer inductor, in a case where the same coils are disposed in parallel, a difference in inductance values occurs due to variation in positional accuracy of a manufacturing process or a magnetic circuit, or the like. Particularly, in a case where the multilayer inductor is used as a power inductor, there is a problem that magnetic interference occurs between adjacent coils, and an inductance value in a second inductor varies depending on a usage of a first inductor.

Therefore, conventionally, in the following Patent Literature 1, there is proposed a mixing electronic part, in which a slit extending in a thickness direction is formed between two inductors in a laminated body where green sheets are laminated and the two inductors are disposed, and a nonmagnetic body is filled in this slit, so that inductive coupling between the inductors formed on the both sides with the nonmagnetic body interposed therebetween is prevented.

The following Patent Literature 2 discloses a hybrid integrated circuit part, in which four inductors are disposed and formed by lamination by printing insulating paste and conductor paste in sequence, and a nonmagnetic layer is printed in a cross shape so as to be located between the four inductors in the above printing, and to be overlapped and formed, so that influence of a magnetic flux generated in the one inductor on the adjacent inductor is suppressed by the above nonmagnetic layer.

### CITATION LIST

### Patent Literature

### [Patent Literature 1]

Japanese Patent Laid-Open No. 5-308021

### [Patent Literature 2]

Japanese Patent Laid-Open No. 2001-358022

### SUMMARY OF INVENTION

### Technical Problem

However, in the above conventional multilayer inductors, there is a problem that the magnetic layer is formed between the inductors (coils), and therefore it is necessary to ensure a slit or a space for printing the nonmagnetic layer, which causes waste in design. Additionally, the slit is formed, and the nonmagnetic body is filled, or the cross shaped nonmagnetic layer is printed per each layer, and therefore much labor is required and the number of manufacturing processes is increased.

The present invention has been made in view of the above circumstances, and an object of the invention is to provide a multilayer inductor capable of reducing a difference in inductance values by using a simple method, and suppressing the occurrence of magnetic interference.

### Solution to Problem

In order to solve the problem, according to the invention recited in claim 1, a multilayer inductor including: a plurality of electrically insulating magnetic layers that are laminated; and conductive patterns that are laminated, each of the conductive patterns being connected in sequence in the lamination direction to form spirally circulating coils, both ends of each of the coils being drawn out to an outer peripheral part, wherein the coils are two coils having substantially the same number of turns and substantially the same coil diameter, and are disposed in parallel such that each of the coils has a relation of a mirror image with respect to a virtual surface between the coils, and the ends of each coil are located at the outer peripheral part on a side opposite to the virtual surface, and at least one electrically insulating nonmagnetic layer is disposed only inside the coils in the lamination direction in place of the magnetic layers.

According to the invention recited in claim 2, a multilayer inductor including: a plurality of electrically insulating magnetic layers that are laminated; and conductive patterns that are laminated, each of the conductive patterns being connected in sequence in the lamination direction to form spirally circulating coils, both ends of each of the coils being drawn out to an outer peripheral part, wherein the coils are two coils having substantially the same number of turns and substantially the same coil diameter, and are disposed in parallel such that each of the coils has a relation of a mirror image with respect to a virtual surface between the coils, and the ends of each coil are located at the outer peripheral part on a side opposite to the virtual surface, and at least one electrically insulating nonmagnetic layer is disposed inside the coils and at an outer peripheral portion of the multilayer inductor where the ends are disposed, outside the coils, in the lamination direction in place of the magnetic layers.

According to the invention recited in claim 3, in the invention recited in claim 1 or 2, an electrically insulating nonmagnetic pattern having a shape corresponding to a shape of each of the conductive patterns is disposed between the conductive patterns adjacent in the lamination direction, and the nonmagnetic layer is formed so as to be continuous to the nonmagnetic pattern.

In the invention recited in claims 1 to 3, “the numbers of turns and the coil diameters are almost equal” means that the numbers of turns are the same, and the coil diameters are equal within a range of a printing error and/or a manufacturing error in the conductive patterns and connection parts.

### Advantageous Effects of Invention

According to the invention recited in any of claims 1 to 3, the two coils having substantially the same number of turns and substantially the same coil diameter are disposed such that each of the coils has the relation of the mirror image with respect to the virtual surface between the coils, and therefore magnetic circuits formed by both the coils become equal. As a result, it is possible to reduce a difference in inductance values.

Furthermore, at least the one nonmagnetic layer is disposed inside each of the coils, so that a magnetic gap is formed, which makes it difficult for a magnetic flux generated by one of the coils to pass through the inside of the other coil. Therefore, it is possible to suppress the influence of one of the coils on the inductance of the other coil.

Additionally, it is not necessary that a slit be formed between the coils like a conventional multilayer inductor, or that a non-insulating layer be printed. Therefore, it is possible to avoid waste design in space. Additionally, manufacturing processes are simplified. Particularly, according to the invention recited in claim 3, the nonmagnetic layer and the nonmagnetic pattern are formed by printing or the like at the same time during manufacturing, and therefore it is possible to attain further simplification of the manufacturing processes.

Moreover, in the invention recited in claim 2, the nonmagnetic layer which becomes the magnetic gap is formed not only inside the coils but also at the outer peripheral portions where the ends of the coils are disposed and the number of turns is increased, outside the coils. Therefore, also in a case where position deviation occurs in the inner coils in a cutting process in manufacturing of the multilayer inductor, when the position deviation is in a cutting precision range, a difference in inductance values scarcely occurs. In addition, it is possible to flatten DC superposition characteristics in a low load.

### BRIEF DESCRIPTION OF DRAWINGS

FIG. 1A is a plan view illustrating a first embodiment of the present invention, and illustrating the coil placement.

FIG. 1B is a B-B line sectional view of FIG. 1A.

FIG. 1C is a C-C line sectional view of FIG. 1A,

FIG. 2A is a plan view illustrating a second embodiment of the present invention, and illustrating the coil placement.

FIG. 2B is a B-B line sectional view of FIG. 2A.

FIG. 2C is a C-C line sectional view of FIG. 2A.

FIG. 3A is a plan view illustrating a third embodiment of the present invention, and illustrating the coil placement.

FIG. 3B is a B-B line sectional view of FIG. 3A.

FIG. 3C is a C-C line sectional view of FIG. 3A.

FIG. 4A is a plan view illustrating the coil placement of a multilayer inductor used as Comparative Example 1 in Example.

FIG. 4B is a B-B line sectional view of FIG. 4A.

FIG. 4C is a C-C line sectional view of FIG. 4A.

FIG. 5A is a plan view illustrating the coil placement of a multilayer inductor used as Comparative Example 2 in Example.

FIG. 5B is a B-B line sectional view of FIG. 5A.

FIG. 5C is a C-C line sectional view of FIG. 5A.

FIG. 6A is a graph illustrating the DC superposition characteristics of Example 1 in the above Example.

FIG. 6B is a graph illustrating the DC superposition characteristics of Example 1 in the above Example.

FIG. 7A is a graph illustrating the DC superposition characteristics of Example 1 in the above Example.

FIG. 7B is a graph illustrating the DC superposition characteristics of Example 2 in the above Example.

FIG. 8A is a graph illustrating the DC superposition characteristics of Comparative Example 1 in the above Example.

FIG. 8B is a graph illustrating the DC superposition characteristics of Comparative Example 1 in the above Example.

FIG. 9A is a graph illustrating the DC superposition characteristics of Comparative Example 2 in the above Example.

FIG. 9B is a graph illustrating the DC superposition characteristics of Comparative Example 2 in the above Example.

FIG. 10A is a plan view illustrating an example in a case where position deviation of coils occurs in the above Example.

FIG. 10B is a plan view illustrating an example in a case where position deviation of coils occurs in the above Example.

FIG. 10C is a plan view illustrating an example in a case where position deviation of coils occurs in the above Example.

### DESCRIPTION OF EMBODIMENTS

### First Embodiment

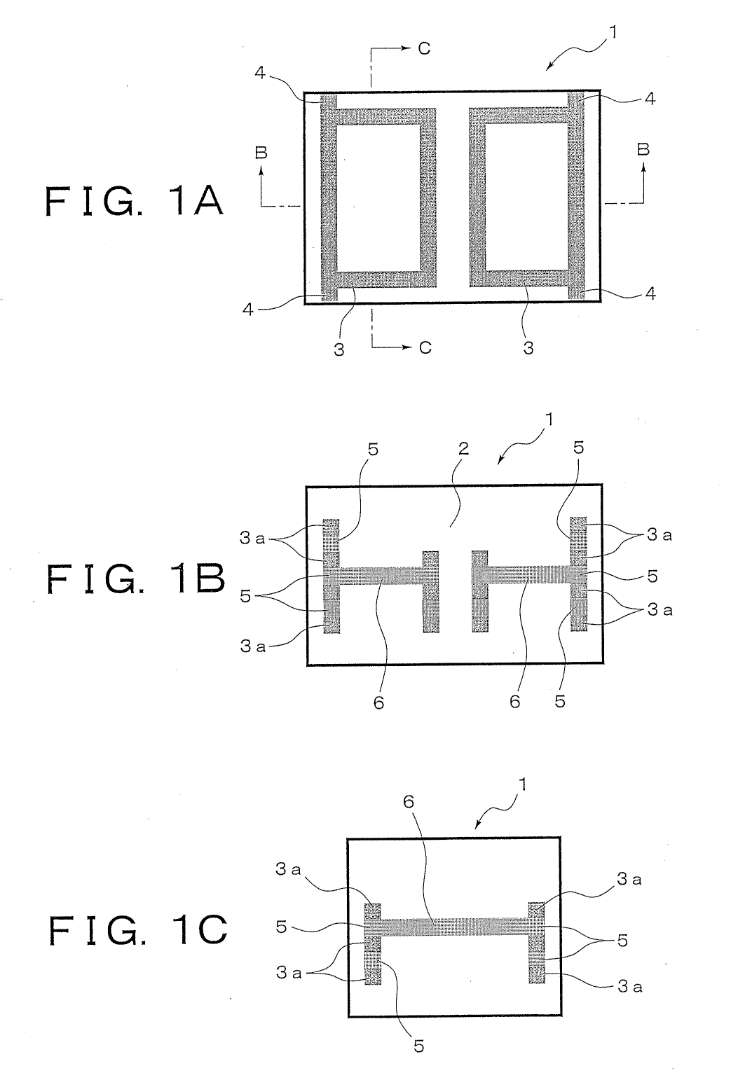

FIG. 1A, FIG. 1B, FIG. 1C each illustrates a first embodiment of a multilayer inductor according to the present invention. This multilayer inductor 1 is formed in a rectangular parallelepiped shape, in which a plurality of electrically insulating magnetic layers 2 and conductive patterns 3a are laminated, and each of the conductive patterns 3a is connected in sequence in a lamination direction, so that spirally circulating coils 3 are formed, and both ends 4 of each of the coils 3 are drawn out to an outer peripheral part. The ends 4 of each coil 3 that are drawn out to the outer peripheral part are connected to a land of a circuit board (not shown), so that the multilayer inductor 1 is surface-mounted.

In the multilayer inductor 1 of this embodiment, the two coils 3, which have the same numbers of turns, and have coil diameters equal in a manufacturing error range, are disposed in parallel in the magnetic layers 2 such that mutual axes are parallel to each other. Herein, these coils 3 are disposed such that each coil 3 has a relation of a mirror image with respect to a virtual surface between the coils 3. Additionally, the coils 3 are disposed such that the ends 4 of each coil 3 are located at the outer peripheral part on a side opposite to the above virtual surface, more specifically, such that the ends 4 of each coil 3 are located near the corner parts of the long side parts of the multilayer inductor 1.

Then, between the conductive patterns 3a adjacent in the lamination direction, an electrically insulating nonmagnetic pattern 5 having a shape corresponding to the shape of each of the conductive patterns 3a are disposed. Furthermore, in this multilayer inductor 1, a magnetic gap is not formed between the coils 3, and an electrically insulating nonmagnetic layer 6 that becomes the magnetic gap is disposed by one layer in the lamination direction only inside each coil 3 in place of the magnetic layers 2. Incidentally, the nonmagnetic layer 6 is formed so as to be continuous to the nonmagnetic pattern 5 disposed between the conductive patterns 3a.

In order to manufacture the above configured multilayer inductor 1, paste of an electrically insulating material such as a Ni—Zn based ferrite material is first printed by a screen printing method or the like, so that a magnetic layer 2 is formed, a conductive pattern 3a is printed on this magnetic layer 2, and a magnetic layer 2 is printed at a portion except the conductive pattern 3a. Next, electrically insulating paste such as a Zn ferrite material having a shape corresponding to the shape of this conductive pattern 3a is printed on the conductive pattern 3a, so that a nonmagnetic pattern 5 is formed, and a magnetic layer 2 is formed on a portion except each of the nonmagnetic patterns 5.

Thus, in the magnetic layers 2, the conductive patterns 3a and the nonmagnetic patterns 5 are alternately laminated, and the electrically insulating paste such as the Zn ferrite material which is the same as the nonmagnetic patterns 5 is printed as the fifth layer in the figure, so that the nonmagnetic layer 6 is formed. At this time, the nonmagnetic layer 6 is continuous to the nonmagnetic pattern 5 to be printed, and a magnetic layer 2 is similarly printed on a portion except these. With this, upper and lower conductive body patterns 3a are electrically connected by utilizing a via hole or the like. Then, the above laminating processes are repeatedly performed, so that it is possible to manufacture the multilayer inductor illustrated in FIG. 1A to FIG. 10.

### Second Embodiment

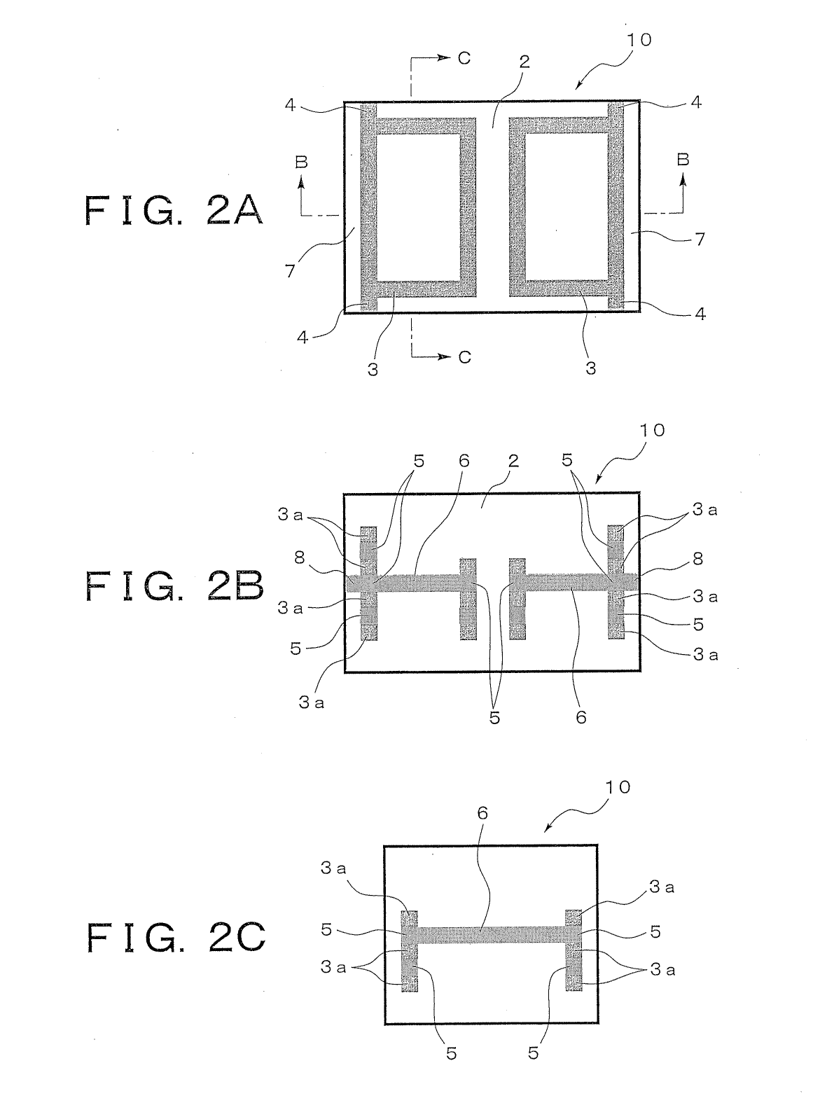

FIG. 2A, FIG. 2B and FIG. 2C each illustrates a second embodiment of a multilayer inductor according to the present invention. Parts having the same configurations as those illustrated in FIG. 1A to FIG. 10 are denoted by the same reference numerals, and the description thereof is simplified.

In a multilayer inductor 10 of this embodiment, in the layer where the nonmagnetic layer 6 is formed inside the coils 3 in the first embodiment, an electrically insulating nonmagnetic layer 8 is disposed on the whole surfaces of outer peripheral portions 7 where ends 4 of coils 3 are disposed, outside the coils 3, in place of the above magnetic layers 2, so as to be continuous to the nonmagnetic layer 6 and a nonmagnetic pattern 5.

### Third Embodiment

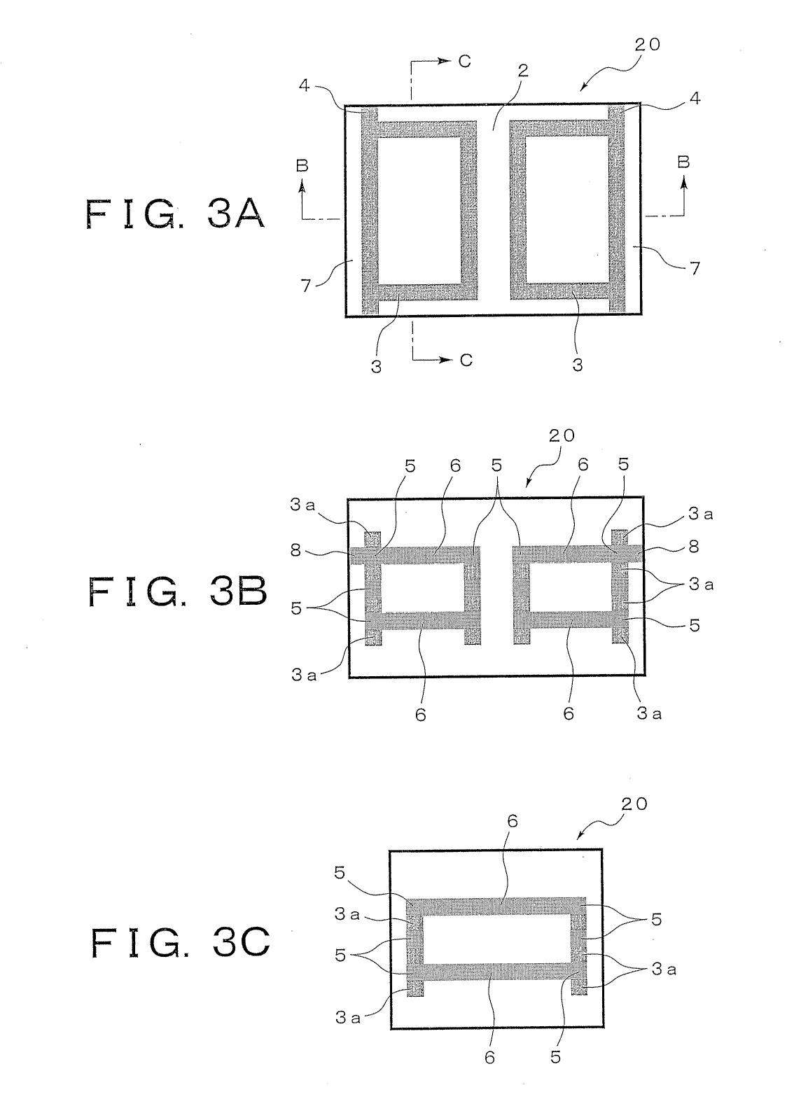

FIG. 3A, FIG. 3B, FIG. 3C each illustrates a third embodiment of the present invention. In this multilayer inductor 20, a nonmagnetic layer 6 is formed as the third layer inside coils 3 so as to be continuous to a nonmagnetic pattern 5 between conductive patterns 3a, and an electrically insulating nonmagnetic layer 8 is further disposed as the seventh layer on the whole surfaces of outer peripheral portions 7 where ends 4 of the coils 3 are disposed, outside the coils 3, in place of the above magnetic layers 2, so as to be continuous to a nonmagnetic layer 6 inside the coils 3, and a nonmagnetic pattern 5 between conductive patterns 3a.

According to each of the multilayer inductors 1, 10 and 20 having the above configurations, the two coils 3 having substantially the same number of turns and substantially the same coil diameter are disposed such that each coil has a relation of a mirror image with respect to a virtual surface between the coils 3, and therefore magnetic circuits formed by both the coils 3 become equal. As a result, it is possible to reduce a difference in inductance values.

Moreover, inside each of the coils 3, the one nonmagnetic layer 6 is disposed, so that a magnetic gap is formed, which makes it difficult that a magnetic flux generated by one of the coils 3 passes through the inside of the other coil 3. Accordingly, it is possible to suppress influence of one of the coils 3 on the inductance of the other coil 3.

Additionally, the magnetic gap is not disposed between the coils 3, and therefore it is not necessary that a slit is formed between the coils like a conventional multilayer inductor, or that a non-insulating layer is printed. Accordingly, it is possible to avoid waste design in space. Additionally, the nonmagnetic layer 6 and the nonmagnetic pattern 5 are formed by printing or the like at the same time during manufacturing, and therefore it is possible to attain simplification of the manufacturing processes.

Furthermore, in the multilayer inductors 10 and 20 described in the second and third embodiments, the nonmagnetic layer 6 is formed inside the coils 3, and the magnetic gap formed from the nonmagnetic layer 8 is formed also on the whole surfaces of the outer peripheral portions 7 where the ends 4 of the coils 3 are disposed and the number of turns is increased, outside the coils 3. Therefore, also in a case where position deviation occurs in the inner coils 3 in a cutting process in manufacturing, when the position deviation is in a cutting precision range, a difference in inductance values scarcely occurs. In addition, it is possible to flatten DC superposition characteristics in a low load.

### EXAMPLE

In order to verify an effect of the present invention, as a multilayer inductor according to the present invention, a trial product of a multilayer inductor (Example 1, “mirror image, center”) having the configuration of the first embodiment, and a trial product of a multilayer inductor (Example 2, “mirror image, fin”) having the configuration of the second embodiment were manufactured.

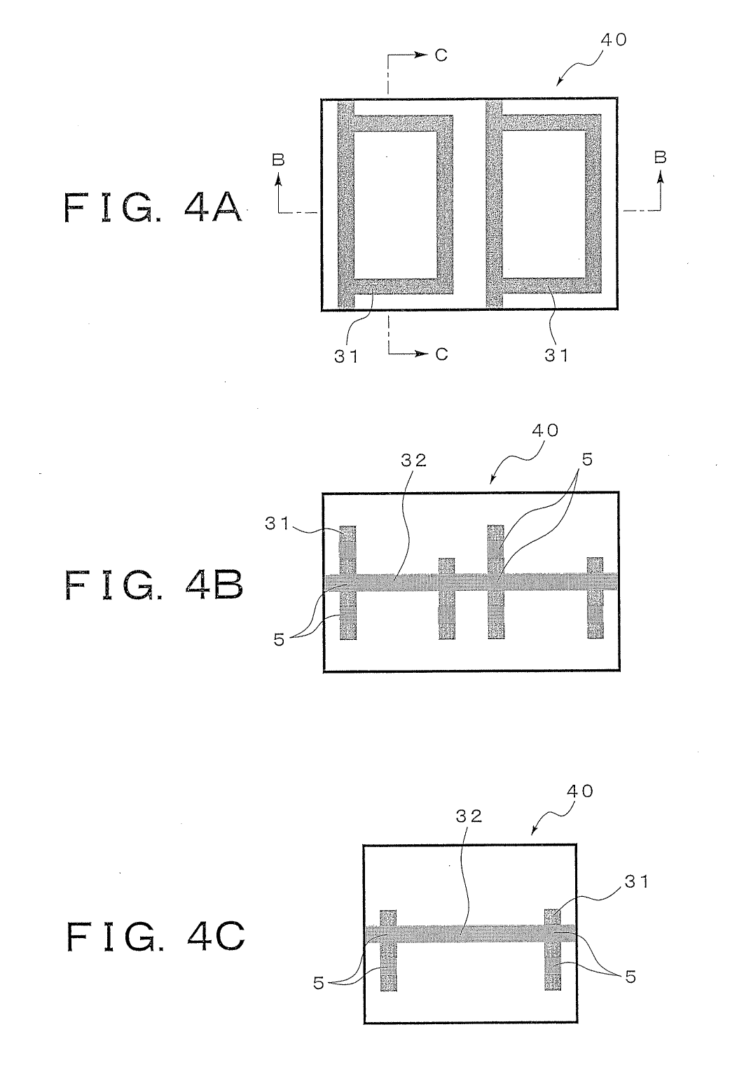

Additionally, multilayer inductors 40 and 50 having configurations illustrated in FIG. 4A to FIG. 4C and FIG. 5A to FIG. 50 were manufactured as comparative examples. The multilayer inductor 40 illustrated in FIG. 4A to FIG. 4C is formed such that in the multilayer inductor of the first embodiment, two coils 31 are disposed in parallel so as not to have a relation of a mirror image but to have a relation of mutual parallel movement, and a nonmagnetic layer 32 is formed over the whole surface of the multilayer inductor 40 in place of the nonmagnetic layer 6 disposed only inside the coils 3 so as to be continuous to a nonmagnetic pattern 5 (Comparative Example 1, “parallel, whole surface”).

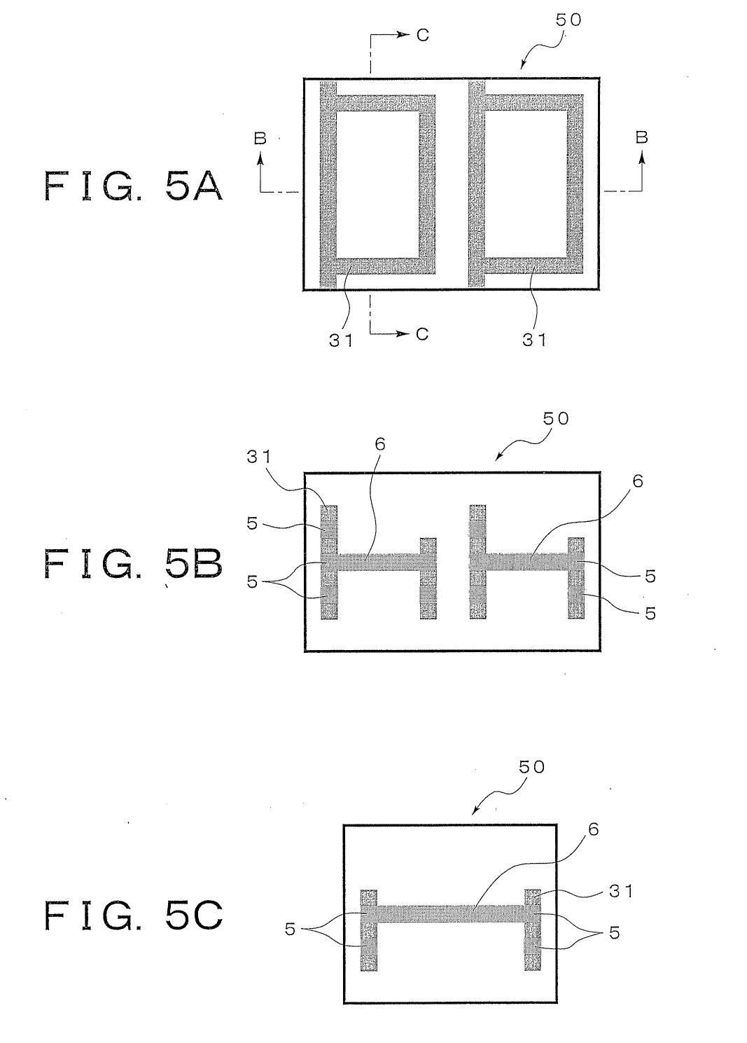

The multilayer inductor 50 illustrated in FIG. 5A to FIG. 5C is formed such that in the multilayer inductor of the first embodiment, two coils 31 are disposed in parallel so as not to have a relation of a mirror image but to have a relation of mutual parallel movement, and a nonmagnetic layer 6 is disposed only inside the coils 3 similarly to the first embodiment (Comparative Example 2, “parallel, center”).

Then, the DC superposition characteristics of the following two cases were measured. The following two coils 3 and 31 are expressed as 3 (L1, L2), 31 (L1, L2), respectively. The coils 3 and 31 have the same number of turns and the same coil diameter.

First, in order to confirm how much a magnetic flux generated by a current flowing in each of the first coils 3 (L1) and 31 (L1) influences an inductance value of each of the second coils 3 (L2) and 31 (L2), the DC superposition characteristics of the both coils were measured in a state where bias currents were not applied to the second coils 3 (L2) and 31 (L2)

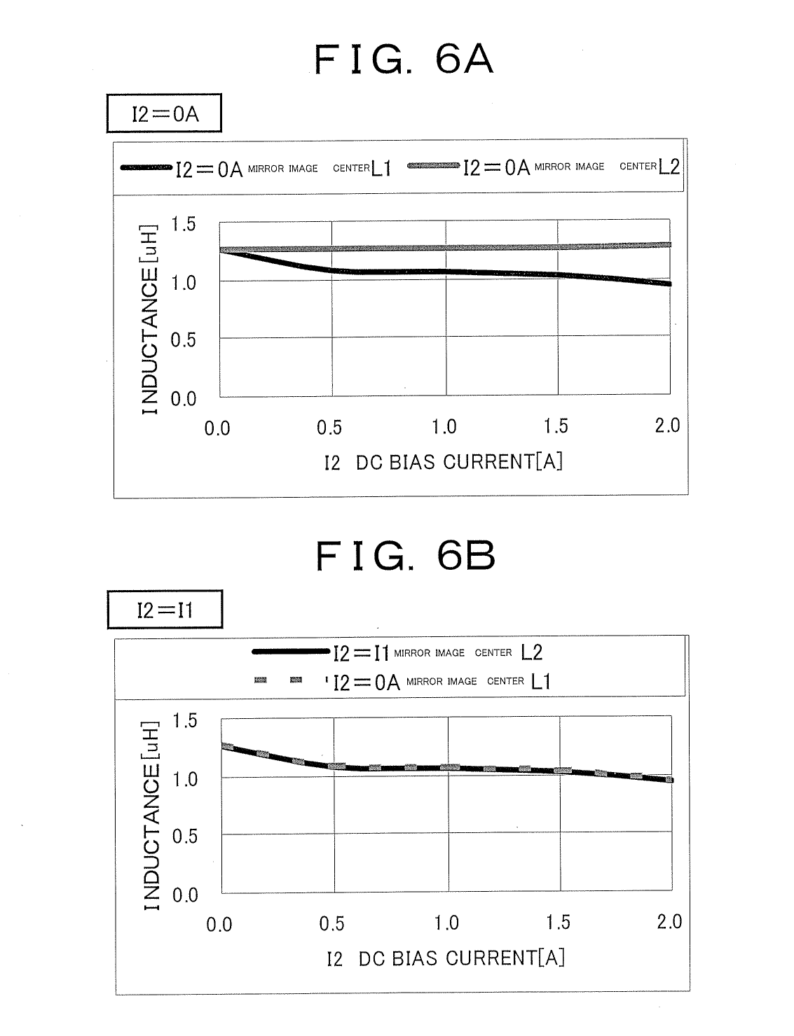

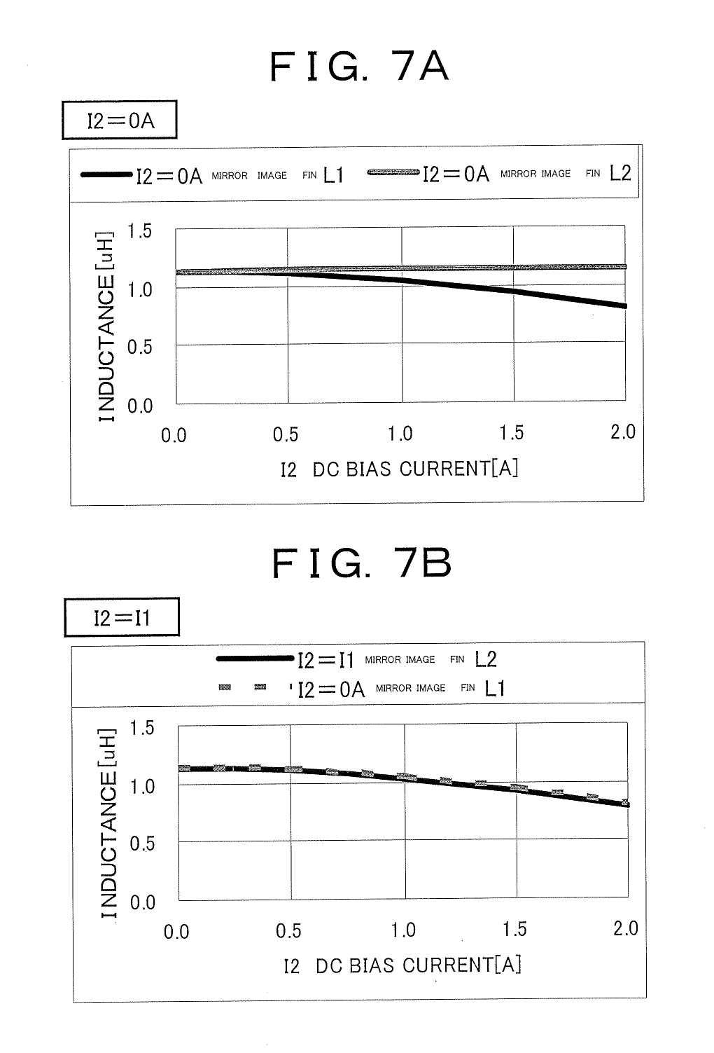

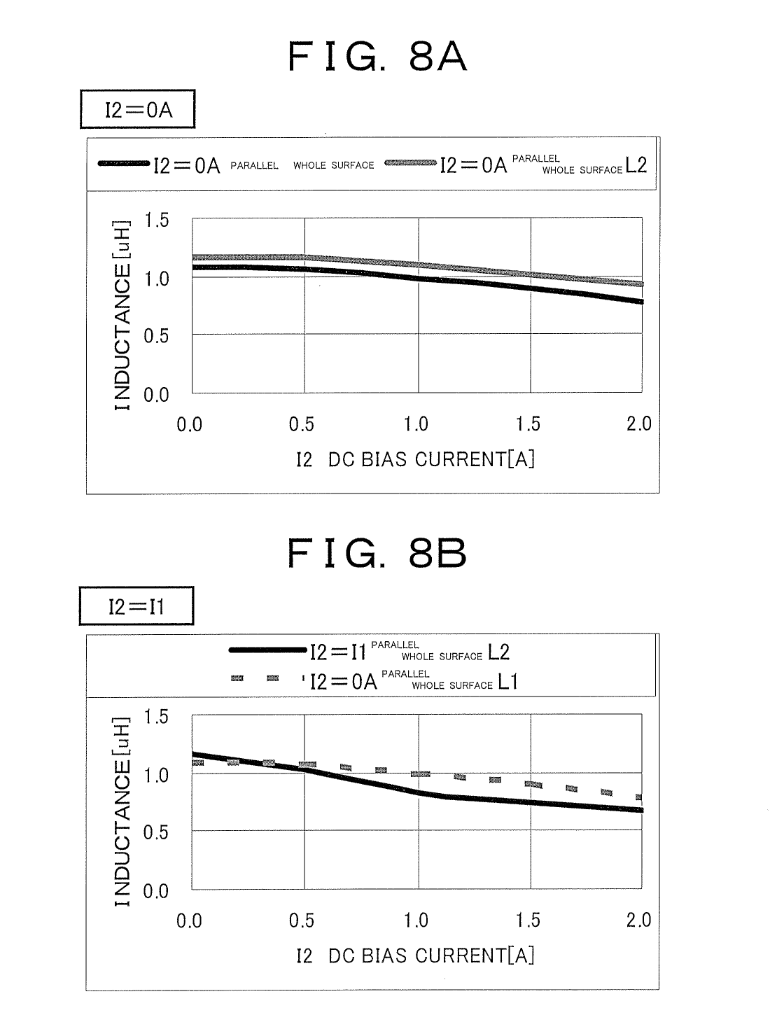

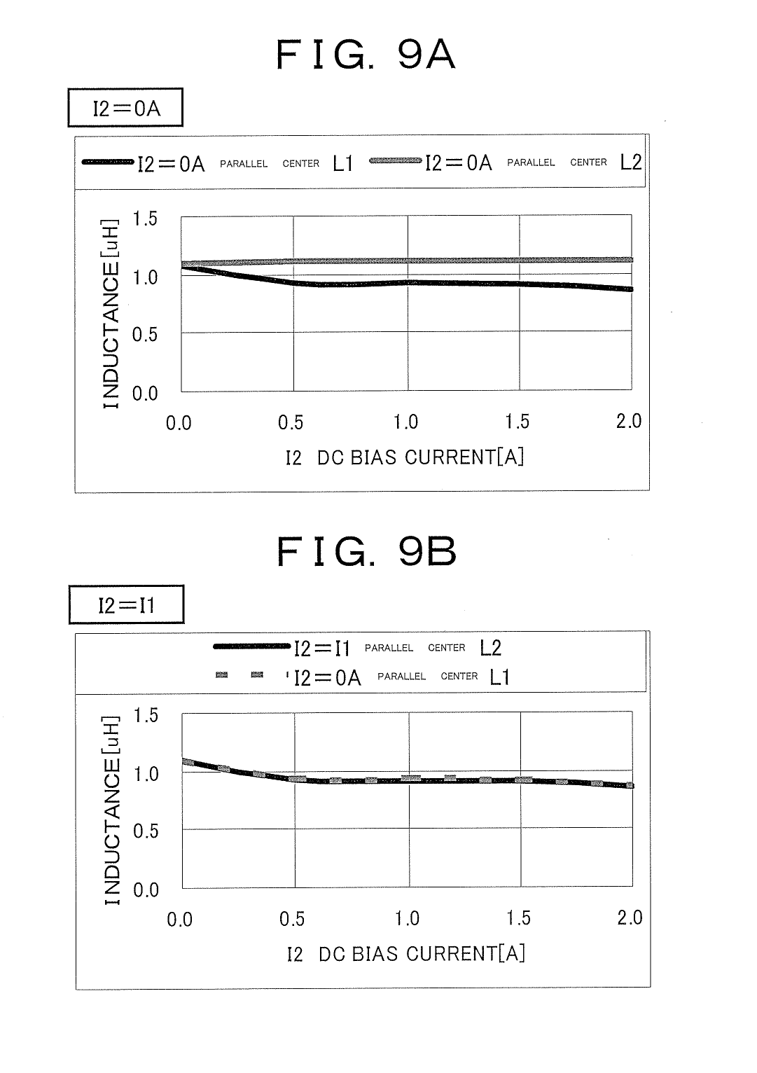

FIG. 6A, FIG. 7A, FIG. 8A and FIG. 9A illustrates the respective results of the measurements in the above Examples 1 and 2 and Comparative Examples 1 and 2.

From these graphs of the DC superposition characteristics, it has been verified that in a case where the nonmagnetic layer 6 was disposed only inside the coils 3 and 31 like the multilayer inductors of Examples 1 and 2 and Comparative Example 2, and in a case where the nonmagnetic layer 8 is disposed inside the coils 3 and 31 and on the whole surfaces of the outer peripheral portions 7 where the ends 4 of the coils 3 were disposed, in addition to the above nonmagnetic layer 6, the changes of the inductance values of the second coils 3 (L2) and 31 (L2) were smaller compared to the multilayer inductor of Comparative Example 1, and therefore the influence of the magnetic fluxes generated by currents flowing in the first coils 3 (L1) and 31 (L1) on the inductance values of the second coils 3 (L2) and 31 (L2) was little.

Next, in order to confirm how much magnetic fluxes generated by currents flowing in the coils 3 (L1, L2) and 31 (L1, L2) mutually influence, the DC superposition characteristics of both the coils 3 (L1, L2) and 31 (L1, L2), to which the same bias currents were applied, were measured.

FIG. 6B, FIG. 7B, FIG. 8B and FIG. 9B illustrate the respective results of the measurements in the above Examples 1 and 2 and Comparative Examples 1 and 2.

In these graphs, it has been verified by comparison of the coils 3 (L1) and 31 (L1) with the coil (L2) and 31 (L2) that the changes of the both in Examples 1 and 2 and Comparative Example 2 are similarly greatly smaller than those in Comparative Example 1. Particularly, in Example 2 of FIG. 7B, rapid changes do not locally occur in the inductance values, and it has been verified from the results that the stable DC superposition characteristics of both the coils 3 (L1, L2) are obtained.

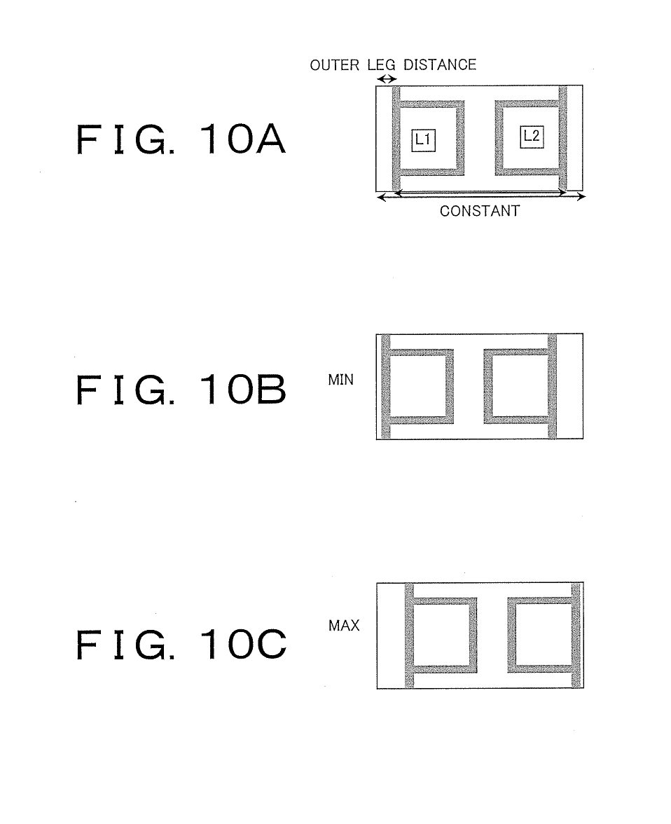

In the manufacturing of the multilayer inductor, generally, after a laminated body including a plurality of multilayer inductors is manufactured, the laminated body is cut into individual multilayer inductors. In many cases, the cutting is performed by pressing and cutting. In the cutting by this pressing and cutting, an actual cut portion is deviated from a design value. As a result, it is unavoidable that coil positions in the respective multilayer inductors are changed as illustrated in FIG. 10A, FIG. 10B and FIG. 10C.

In such a case, it has been verified how much the inductances are changed.

Table 1 is a table showing changes of the inductances of FIG. 10A to FIG. 10C, and shows changes of inductance values of Example 1 “center”, Example 2 “fin”, and Comparative Example 3 “whole surface” in which the nonmagnetic layer is formed over the whole surface in place of the nonmagnetic layer 6 of Example 1, in a case where distances between the outsides (outer legs) of the coils and cut edges are changed, as illustrated in FIG. 10A to FIG. 10C.

TABLE 1

| | | | | | Inductance | | | |
|---|---|---|---|---|---|---|---|---|
| | | Outer leg distance | | | | | | Change |
| | | MIN | Center | MAX | MAX | MIN | Difference | amount |
| L1 | Whole surface | 1.1225 | 1.1843 | 1.2232 | 1.2232 | 1.1225 | 0.1006 | 8.6% |
| | Center | 1.2002 | 1.2615 | 1.2626 | 1.2626 | 1.2002 | 0.0624 | 5.0% |
| | Fin | 1.1198 | 1.1346 | 1.1408 | 1.1408 | 1.1198 | 0.0210 | 1.9% |

As seen in Table 1, it has been verified that the change amounts of the inductance values in Example 1 and Example 2 are smaller than those in Comparative Example 3 “whole surface”. Particularly, according to Example 2, it has been verified that the above change amounts can be further reduced.

### INDUSTRIAL APPLICABILITY

It is possible to provide a multilayer inductor capable of reducing a difference in inductance values by using a simple method, and suppressing the occurrence of magnetic interference.

### REFERENCE SIGNS LIST

1, 10, 20, 40, 50 Multilayer inductor
2 Magnetic layer
3 Coil
3a Conductive pattern
4 End
5 Nonmagnetic pattern
6, 8 Nonmagnetic layer
7 Outer peripheral portion

1. A multilayer inductor comprising:
a plurality of electrically insulating magnetic layers that are laminated; and
conductive patterns that are laminated, each of the conductive patterns being connected in sequence in the lamination direction to form spirally circulating coils, both ends of each of the coils being drawn out to an outer peripheral part, wherein
the coils are two coils having substantially the same number of turns and substantially the same coil diameter, and are disposed in parallel such that each of the coils has a relation of a mirror image with respect to a virtual surface between the coils, and the ends of each coil are located at the outer peripheral part on a side opposite to the virtual surface, and
at least one electrically insulating nonmagnetic layer is disposed only inside the coils in the lamination direction in place of the magnetic layers.

2. A multilayer inductor comprising:
a plurality of electrically insulating magnetic layers that are laminated; and
conductive patterns that are laminated, each of the conductive patterns being connected in sequence in the lamination direction to form spirally circulating coils, both ends of each of the coils being drawn out to an outer peripheral part, wherein
the coils are two coils having substantially the same number of turns and substantially the same coil diameter, and are disposed in parallel such that each of the coils has a relation of a mirror image with respect to a virtual surface between the coils, and the ends of each coil are located at the outer peripheral part on a side opposite to the virtual surface, and
at least one electrically insulating nonmagnetic layer is disposed inside the coils and at an outer peripheral portion of the multilayer inductor where the ends are disposed, outside the coils, in the lamination direction in place of the magnetic layers.

3. The multilayer inductor according to claim 1 wherein
an electrically insulating nonmagnetic pattern having a shape corresponding to a shape of each of the conductive patterns is disposed between the conductive patterns adjacent in the lamination direction, and
the nonmagnetic layer is formed so as to be continuous to the nonmagnetic pattern.

4. The multilayer inductor according to claim 2 wherein
an electrically insulating nonmagnetic pattern having a shape corresponding to a shape of each of the conductive patterns is disposed between the conductive patterns adjacent in the lamination direction, and
the nonmagnetic layer is formed so as to be continuous to the nonmagnetic pattern.
